(19) United States
(12) Patent Application Publication
(10) Pub. No.: US 2013/0085777 A1
(43) Pub. Date: Apr. 4, 2013

(54) Method and System for Wound Prevention, Management and Treatment

(71) Applicants: Anne Scheurich, Chicago, IL (US); Rick Redfield, Wilmette, IL (US); David C. Loveland, Winnetka, IL (US); Beatrice Cruz, Chicago, IL (US)

(72) Inventors: Anne Scheurich, Chicago, IL (US); Rick Redfield, Wilmette, IL (US); David C. Loveland, Winnetka, IL (US); Beatrice Cruz, Chicago, IL (US)

(21) Appl. No.: 13/249,990

(22) Filed: Sep. 30, 2011

(51) Int. Cl. G06Q 50/24

(52) U.S. Cl. 705/3

(57) ABSTRACT

A method and system for wound care and management of patients. The method receives patient information regarding risk assessment and wound assessment relating to pressure ulcers, other wounds, wound severity, tissue types, wound treatment plans, or similar clinical data through a mobile device. The method may also transmit the patient information to a database via the Internet. The method uses the patient information to populate a worksheet, such as an electronic representation of Section M of the MDS 3.0. The method may then display, update, store, and print the worksheet.

### BACKGROUND OF THE INVENTION

1. Field of the Invention

The present invention is in the field of data systems in the healthcare industry. More particularly, the present invention relates to obtaining, inputting, storing, and reporting data related to the management of a patient's wounds.

2. Description of the Prior Art

Methods and systems for managing and treating patient wounds have been disclosed in the prior art by Croghan, U.S. patent application Ser. No. 11/336,036. Such systems utilize handheld computing devices to record clinical data at a patient's bedside during observation and treatment of the patient. Data inputted into the system can then be aggregated into a database for reporting, tracking and analysis. Additionally, algorithms within the system can be used to improve assessment and treatment of the patient.

The Minimum Data Set (MDS) is a reporting form, required of healthcare providers by The Omnibus Budget Reconciliation Act of 1987, to aid nursing homes in gathering consistent information on their patients. Nursing homes must obtain the MDS for each patient on a routine basis after a patient's admission. On Oct. 1, 2010, a new version of MDS, version 3.0, was implemented. Version 3.0 of the MDS increased the data required to be collected by healthcare providers, compared to version 2.0 of the MDS. This volume increase of necessary data presents a new logistical problem to be solved by healthcare providers. Therefore, an algorithm and automated system to aid healthcare workers in meeting the increased data reporting requirements of version 3.0 would increase overall efficiency and regulatory compliance.

An object of the present invention is to aid a clinician in monitoring and recording how a patient's wounds worsen or heal over time.

Another object of the present invention is to aid a clinician in completing Section M of version 3.0 of the Minimum Data Set by extracting available wound, skin, and risk assessment data from a patient record.

Another object of the present invention is to perform this automated completion of version 3.0 of the MDS Section M such that it can be displayed electronically or printed as a form.

Another object of the present invention is to provide a wound assessment program scalable to future data reporting requirements imposed by the federal government.

Another object of the present invention is to incorporate a set of rules into the software application for classifying wounds with regard to a patient's admission to a caretaking facility.

Another object of the present invention is to allow a user to see links, alerts, or messages about a patient's wounds, when multiple wounds exist in the same location of the patient's body.

### SUMMARY OF THE INVENTION

One embodiment of the present invention provides a method for the prevention, management, and/or treatment of wounds, accomplished via a computer hardware and software system.

The method comprises a first step of storing information about a patient. The information about the patient is wound assessment data. This wound assessment data can be information relating to pressure ulcers, other wounds, wound severity, tissue type, wound treatment means, or similar clinical data. In one embodiment of this invention, the data is of a type listed in Section M of the MDS 3.0.

The method comprises a second step of populating a worksheet with the information. The worksheet is an electronic representation of a form. This form can be an electronic form, spreadsheet, chart, diagram, list, or similar record. In an embodiment of the invention, the form is Section M of the MDS 3.0.

The method comprises a third step of dynamically updating and displaying the worksheet.

In a second embodiment of the method, the method has a further step of incorporating a set of rules into the software application. This set of rules can be those for classifying wounds by date, severity, or treatment. In an embodiment of the invention, the set of rules is for classifying wounds with regard to the Present On Admission (POA) and wound worsening standards for Section M of the MDS 3.0.

In a third embodiment of the method, the method has a further step of printing the worksheet as an electronic document. This electronic document could be any commonly used format, such as those used by Adobe, Microsoft Word, Open Office, or Microsoft Excel.

In a fourth embodiment of the method, the method has a further step of printing the worksheet as physical document. The physical document could be any document created by a laser, phaser, or ink jet printer.

In a fifth embodiment of the method, the method has a further step of transmitting the patient information to a server database. The transmission can be accomplished by wireless signal, Ethernet cable, or any similar electronic communication means.

Another embodiment of the invention is a system for the prevention, management, and/or treatment of wounds.

The system has an input device capable of receiving the patient information from a user of the input device. The input device can be any electro-mechanical input device such as a mobile computing device, smart phone, tablet, etc.

The system further has a storage device capable of storing the information. The storage device could be any suitable means to store information over the Internet, such as a SQL server

The system further has a computing device capable of processing and handling the information. The computing device can be any computer or server such as a SSRS report server. This system further includes a display device for displaying patient information to a user of the system. The display device can be any electronic display such as a tablet computer, desktop computer, or monitor. The patient information is the same wound assessment data as discussed in the previous method embodiment. The input device, storage device, computing device and display device may be in any combination of separate devices as would be obvious to one skilled in the art.

Finally, the system has a software application associated with the input device, computing device, storage device and display device. The software application is capable of receiving the patient information from the user and populating a worksheet with the patient information. The software application further dynamically updates and displays this worksheet to the user through the display device. The worksheet is an electronic representation of a form. This electronic representation may be any virtual representation or user interface of a form. In an embodiment of the system, the form is Section M of the MDS 3.0.

In a second embodiment of the system, the software application incorporates a set of rules. The set of rules is for automatically classifying wounds with regard to a patient's admission to a caretaking facility. In an embodiment of the invention, the set of rules is for classifying wounds with regard the Present On Admission (POA) and wound worsening standards for Section M of the MDS 3.0.

In a third embodiment of the system, the software application has an option allowing the user to see links, alerts, or messages. When the option is not enabled by the user, the links, alerts, or messages are suppressed. In an embodiment the alerts are displayed when a plurality of wounds exist for a same wound site.

In a fourth embodiment of the system, the system further has a display device capable of displaying the worksheet as an electronic document. The format of the electronic document is the same as previously discussed in the method embodiment.

In a fifth embodiment of the system, the system further has a printer capable of printing the worksheet as a physical document.

In a sixth embodiment of the system, the system further has a transmitting device. The transmitting device is capable of transmitting the patient information to a server database. The transmission device can be any electronic means to send the patient information via wireless signal, Ethernet cable, or any similar electronic communication means, such as Active Sync, Wi-fi or cable modem, or similar transmission device.

### BRIEF DESCRIPTION OF THE DRAWINGS

The systems, methods, and computer readable media for controlling display objects in accordance with this specification are further described with reference to the accompanying drawings in which:

FIG. 1 is a schematic diagram of a basic infrastructure of an embodiment of the method and system of the present disclosure.

FIG. 2 is a general flow diagram of an embodiment of the method and system of the present disclosure.

FIG. 3 is a general flow diagram of the nursing workflow of an embodiment of the method and system of the present disclosure.

FIG. 4 is an exemplary user interface of one embodiment of the invention.

FIG. 5 is an exemplary user interface of one embodiment of the invention.

FIG. 6 is an exemplary user interface of one embodiment of the invention.

FIG. 7 is an exemplary user interface of one embodiment of the invention.

FIG. 8 is an exemplary user interface of one embodiment of the invention.

FIG. 9 is an exemplary user interface of one embodiment of the invention.

FIG. 10 is an exemplary user interface of one embodiment of the invention.

FIG. 11 is an exemplary user interface of one embodiment of the invention.

FIG. 12 is an exemplary user interface of one embodiment of the invention.

FIG. 13 is an exemplary user interface of a rule section of the invention.

FIG. 14 is an exemplary user interface of a rule section of the invention.

FIG. 15 is an exemplary user interface of a rule section of the invention.

FIG. 16 is an exemplary worksheet from one embodiment of the invention.

FIG. 17 is an exemplary worksheet from one embodiment of the invention.

FIG. 18 is an exemplary worksheet from one embodiment of the invention.

### DETAILED DESCRIPTION OF THE ILLUSTRATED EMBODIMENTS

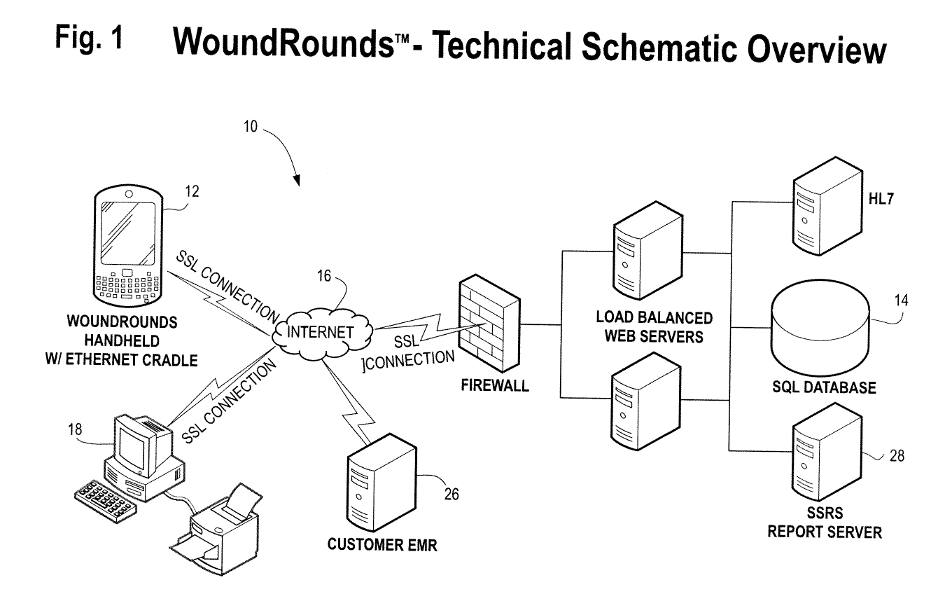

FIG. 1 is a schematic diagram of a basic infrastructure of one embodiment of the method and system of the present disclosure. The basic hardware layout of the system 10 of the present disclosure comprises at least one mobile device 12 for use at the patient's location and a remote database 14 in communication with the mobile device 12 via the Internet 16. One or more computer work stations 18 can also communicate with the database 14 and the mobile device 12. The database 14 can also communicate with the SSRS report server 28.

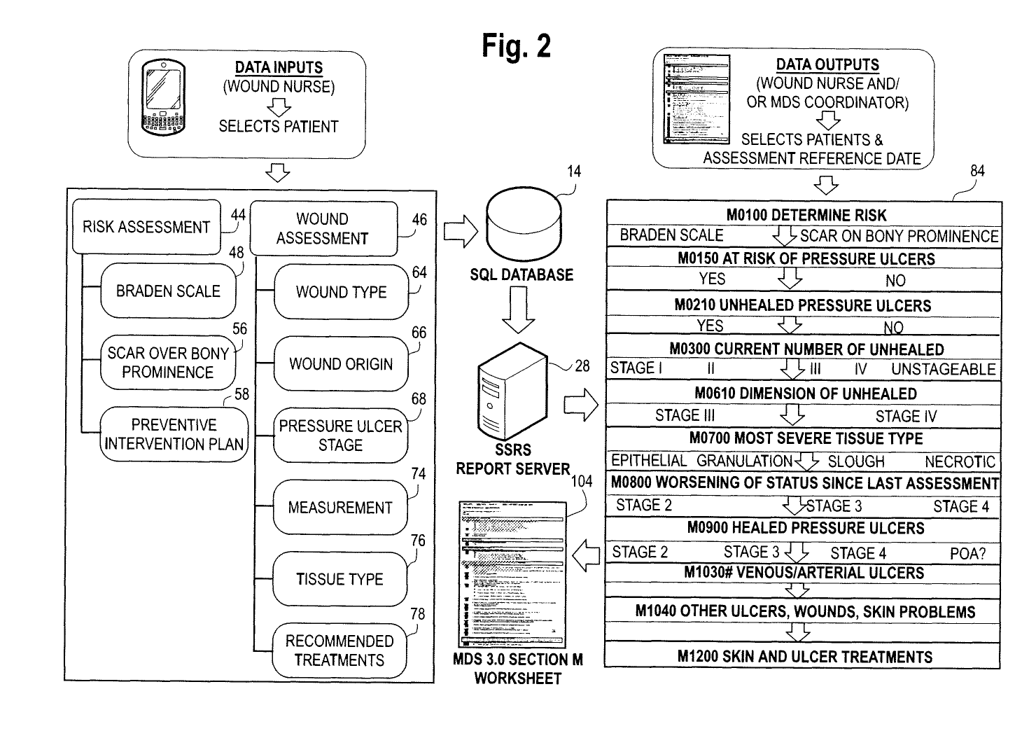

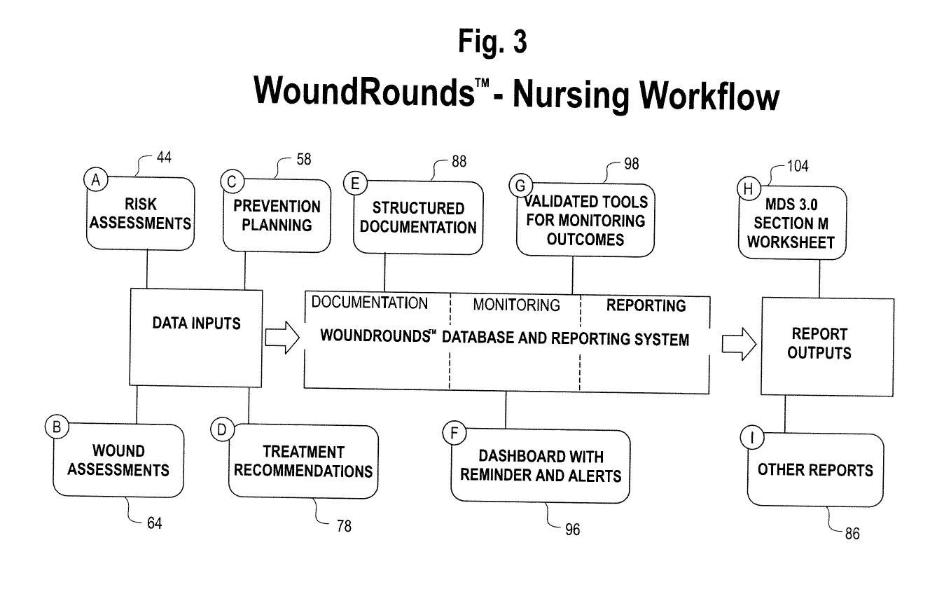

FIG. 2 depicts a general flow diagram of one embodiment of the method and system of the present disclosure and provides a general overview of the data flow through the system to Section M of the MDS 3.0 worksheet. The user opens the application via the mobile device 12 and selects a patient 28. The user inputs data, via the mobile device 12, relating to risk assessment 44, comprising the Braden Scale 48, the scar over bony prominence 56 and the preventive intervention plan 58. The user also inputs data relating to wound assessment 46, comprising wound type 64, wound origin 66, pressure ulcer stage 68, measurement 74, tissue type 76 and recommended treatments 78. The application displays a set of rules for classifying wounds by date, severity, or treatment in accordance with the Present On Admission (POA) and wound worsening standards for Section M of the MDS 3.0. The data inputted is placed in the corresponding fields of an electronic representation of the MDS 3.0 Section M 84 to generate the MDS 3.0 Section M worksheet 104 or any other reports 86, shown in FIG. 3. The user may then store the MDS 3.0 Section M worksheet 104 and other reports 86 as an electronic document or print them out as physical documents. The data outputted, worksheet 104, and other reports 86 may be transmitted to the database 14 and the SSRS report server 28 via the Internet 16.

FIG. 3 depicts a general flow diagram of a preferred embodiment of the method and system of the present disclosure and provides a general overview of the nursing workflow through the system to Section M of the MDS 3.0 worksheet. The database 14 and report server 28 provide structured documentation 88, a dashboard with reminders and alerts 96 and validated tools for monitoring outcomes 98.

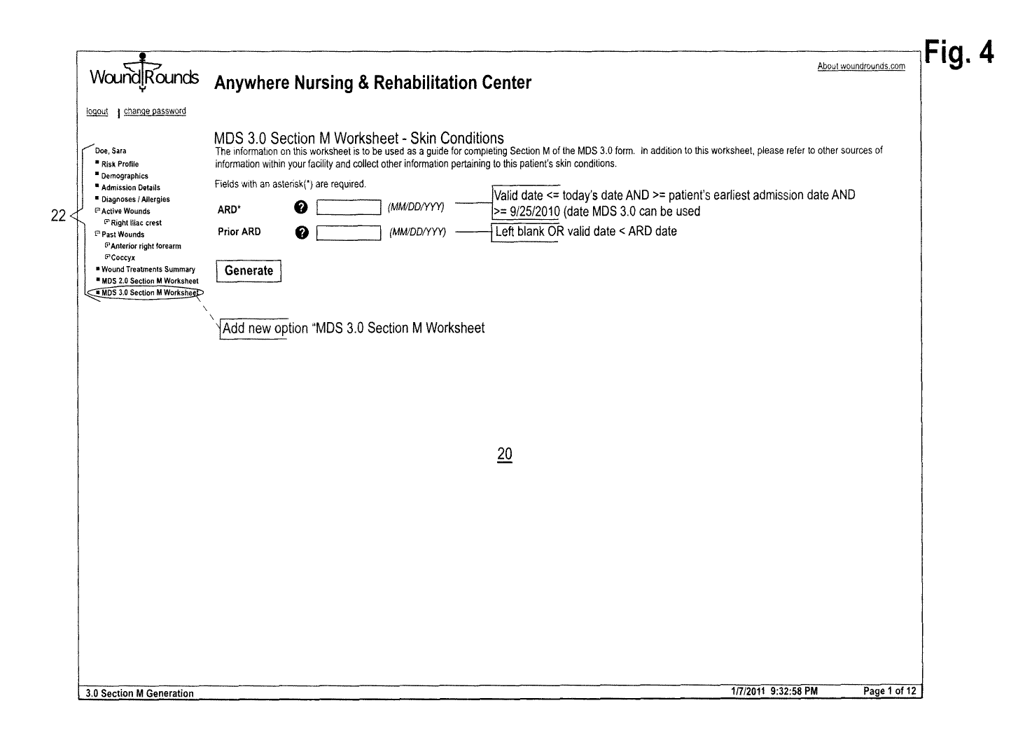

FIG. 4, which depicts an exemplary user interface of an embodiment of the present invention, shows a primary user interface portal 20 of the software application for the prevention, management, and/or treatment of wounds. The software application provides links 22 to functional aspects of the software application. Among these links 22, is a worksheet link 24. The worksheet link 24 is the gateway to the dynamic wound data recording and reporting portion of the software application. The worksheet link 24 enables the user to enter an Assessment Reference Date (ARD) 25, which is used to calculate the data required to update and complete Section M of the MDS 3.0.

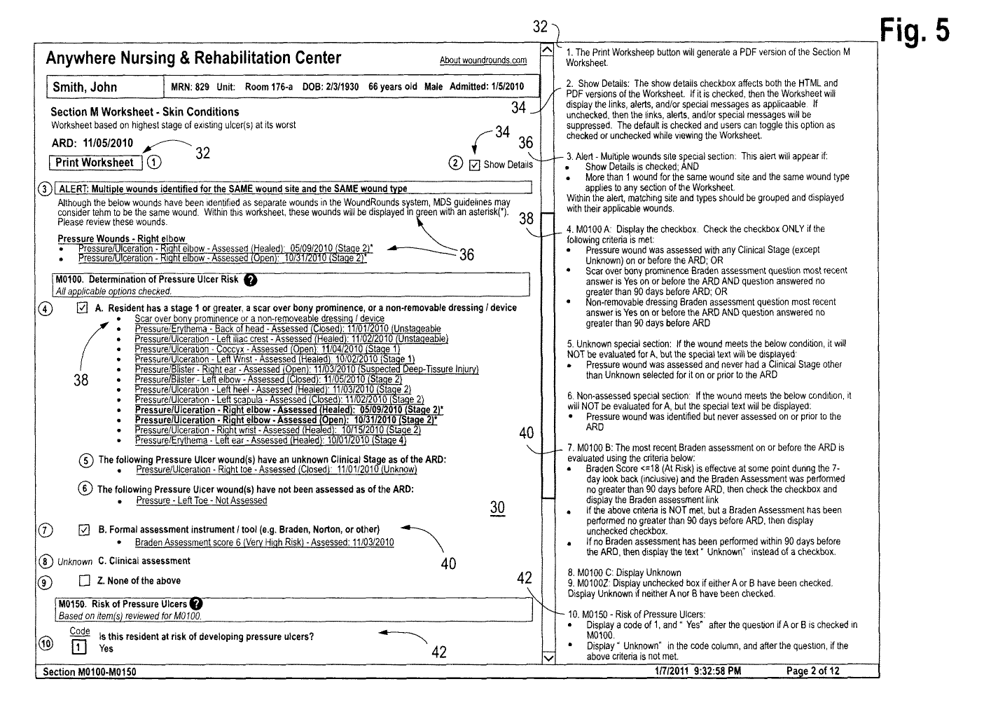

FIG. 5, which depicts an exemplary user interface of an embodiment of the present invention, shows a first dynamic wound worksheet page 30 of the software application for the prevention, management, and/or treatment of wounds. The software application provides a printing link 32 to print the user-selected portions of the entire worksheet. A details area 34 enables and disables the display of alerts and messages section 36. The alerts and messages section 36 displays information to a user if a patient has more than one wound in the same location. A wound summary area 38 displays new or past wounds on the patient's body, while an assessment area 40 displays information on any new or past clinical assessment data concerning the patient's wounds. Finally, a wound risk area 42 allows the user to determine if the patient is in risk of developing new wounds.

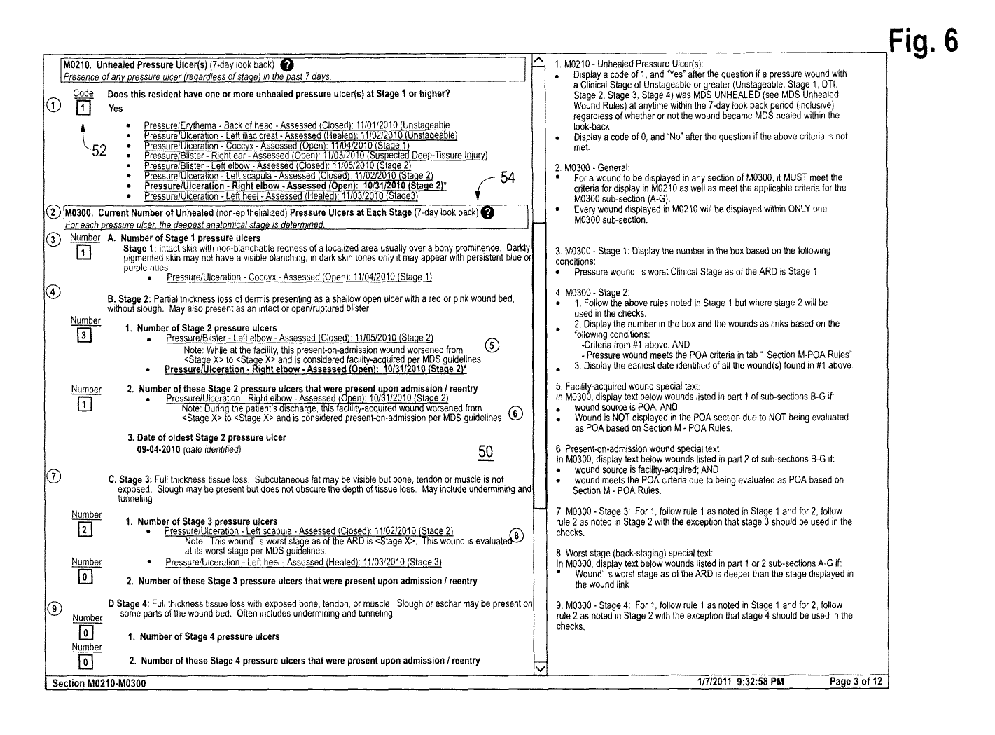

FIG. 6, which depicts an exemplary user interface of an embodiment of the present invention, shows a second dynamic wound worksheet page 50 of the software application for the prevention, management, and/or treatment of wounds. The software application provides an overview wound area 52 displaying information on new or current wounds on the patient. A wound classification area 54 allows the user to quantify, classify, and detail the wounds present on a patient's body.

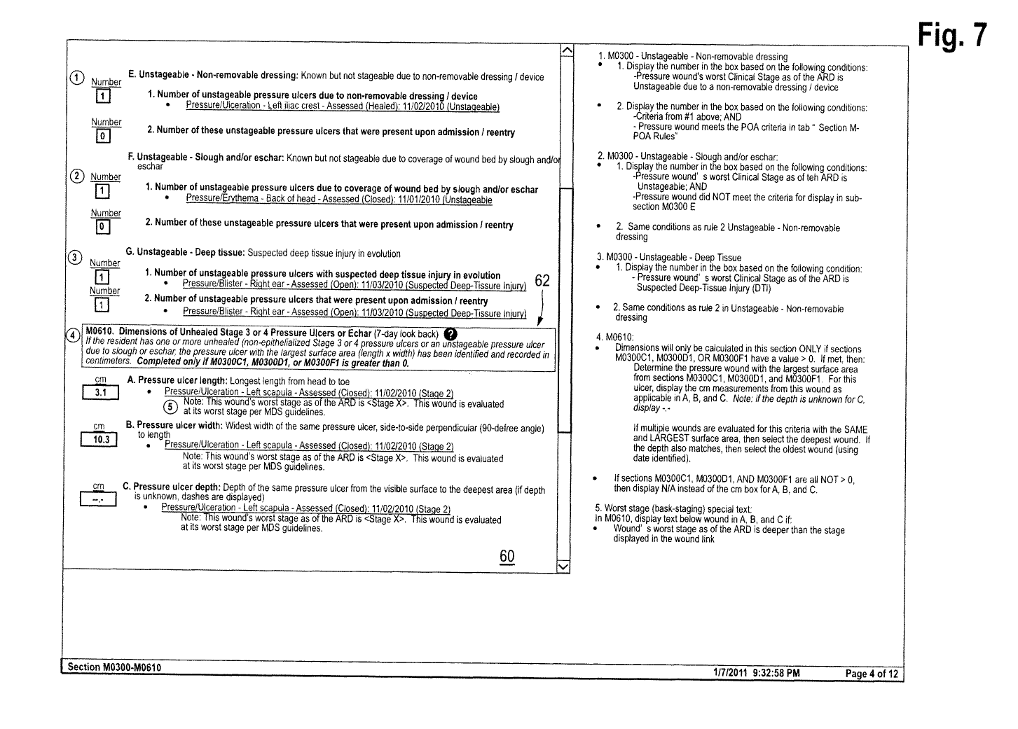

FIG. 7, which depicts an exemplary user interface of an embodiment of the present invention, shows a third dynamic wound worksheet page 60 of the software application for the prevention, management, and/or treatment of wounds. The software application provides a clinical measurement area 62 displaying measurement parameters on new or current wounds on the patient.

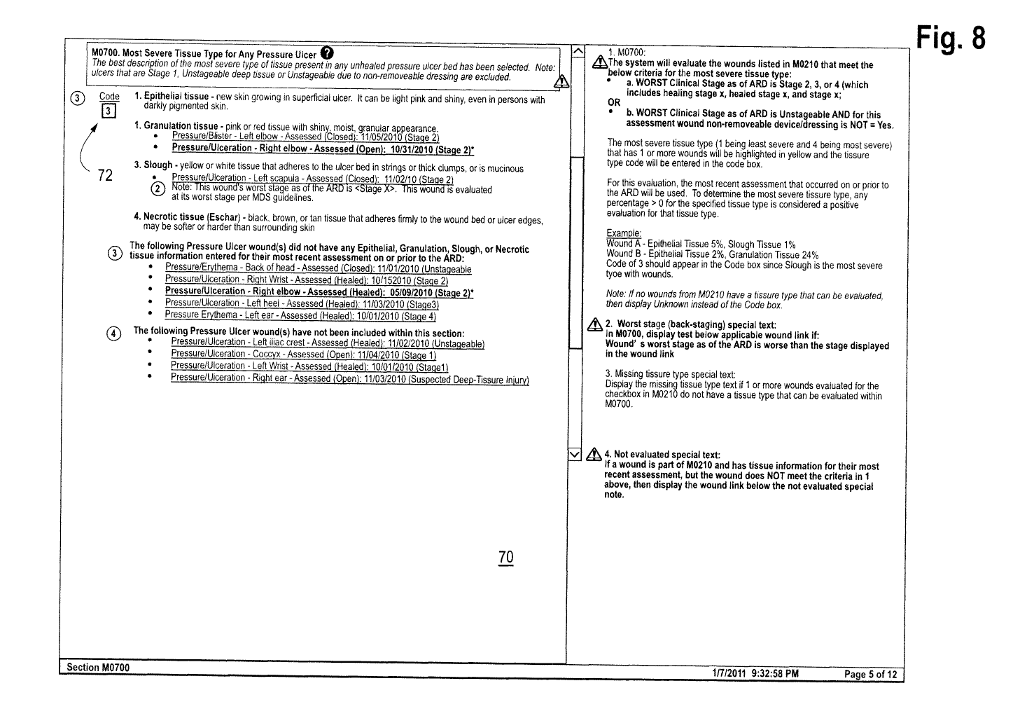

FIG. 8, which depicts an exemplary user interface of an embodiment of the present invention, shows a fourth dynamic wound worksheet page 70 of the software application for the prevention, management, and/or treatment of wounds. The software application provides a wound description area 72 displaying classification data on the most severe tissue type for any pressure ulcer on the patient.

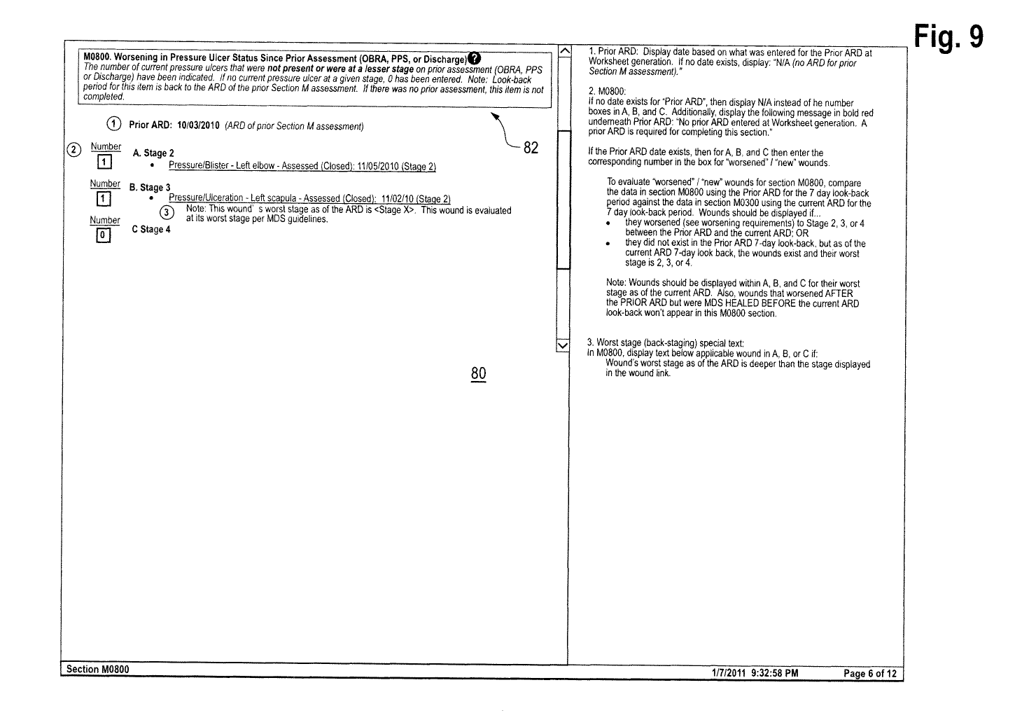

FIG. 9, which depicts an exemplary user interface of an embodiment of the present invention, shows a fifth dynamic wound worksheet page 80 of the software application for the prevention, management, and/or treatment of wounds. The software application provides a worsening wound area 82 displaying a calculation of the number of wounds that worsened on the patient since the prior assessment.

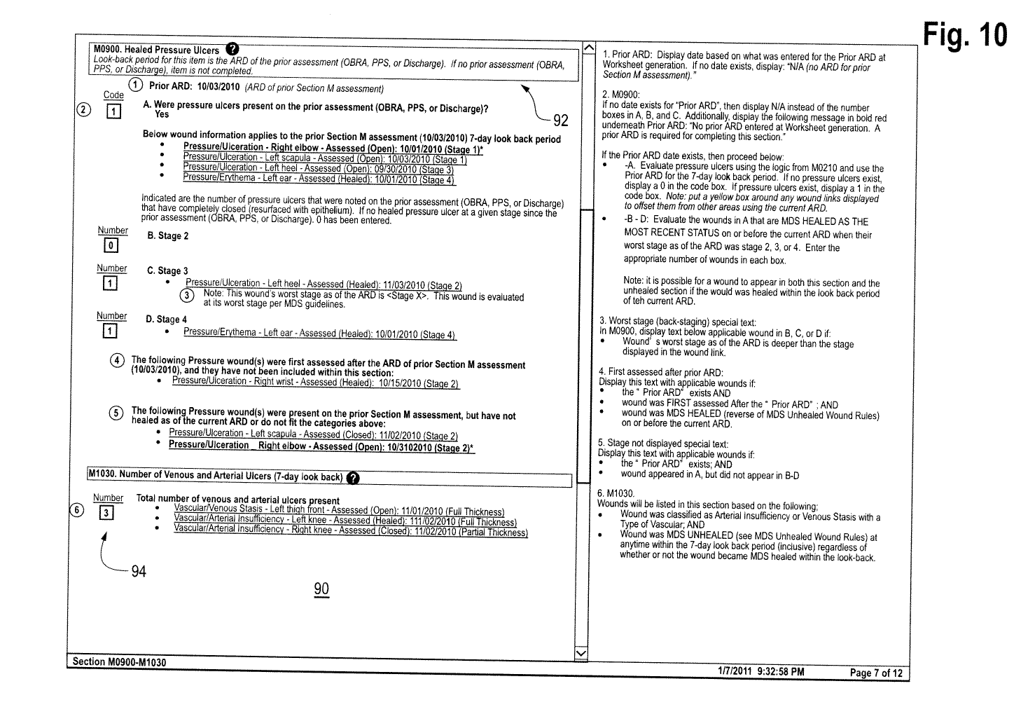

FIG. 10, which depicts an exemplary user interface of an embodiment of the present invention, shows a sixth dynamic wound worksheet page 90 of the software application for the prevention, management, and/or treatment of wounds. The software application provides a healed wound area 92 displaying the number and quality of healed or healing wounds on the patient. Additionally, the software application provides a venous and arterial wound area 94 displaying the number and quality of venous and arterial wounds on the patient.

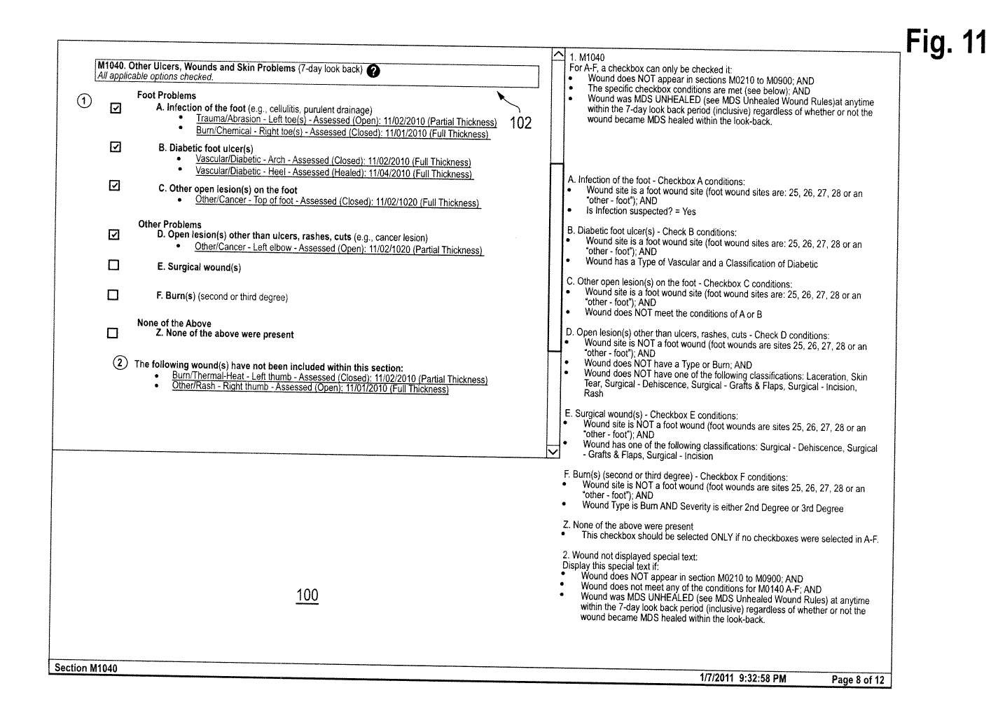

FIG. 11, which depicts an exemplary user interface of an embodiment of the present invention, shows a seventh dynamic wound worksheet page 100 of the software application for the prevention, management, and/or treatment of wounds. The software application provides another wound area 102 displaying the number and quality of other wounds on the patient.

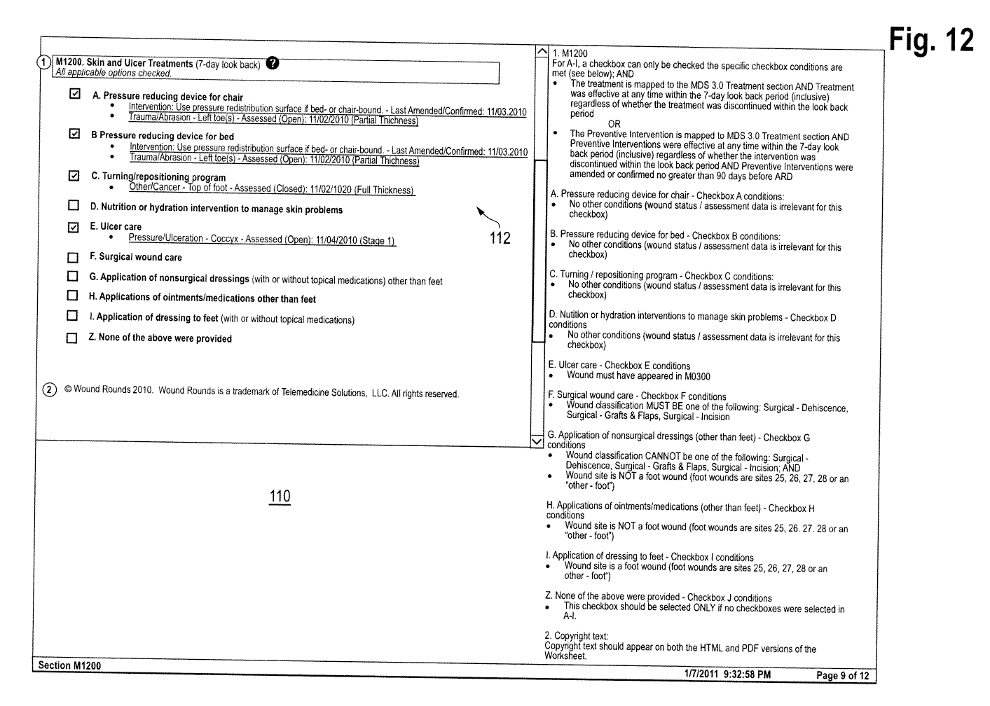

FIG. 12, which depicts an exemplary user interface of an embodiment of the present invention, shows an eighth dynamic wound worksheet page 110 of the software application for the prevention, management, and/or treatment of wounds. The software application provides a wound treatment area 112 displaying the number, location, and quality of treatments given to the patient.

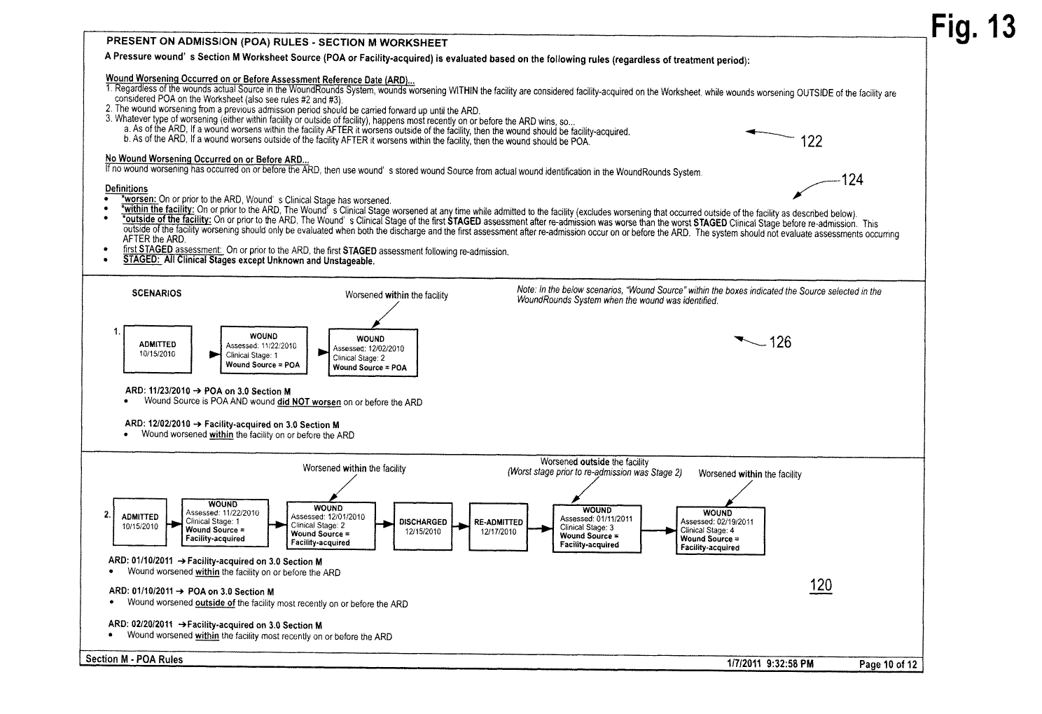

FIG. 13, which depicts an exemplary of an embodiment of the present invention, shows a first rule section page 120 of the software application for the prevention, management, and/or treatment of wounds. The software application provides a rule area 122 displaying the rules of wound classification. A definition section 124 may accompany the rule area 122 to aid the software application in applying the rules to a patient's wounds. Finally, a scenario section 126 may accompany the rules area 122 to further aid in the application of the rules to a patient's wounds.

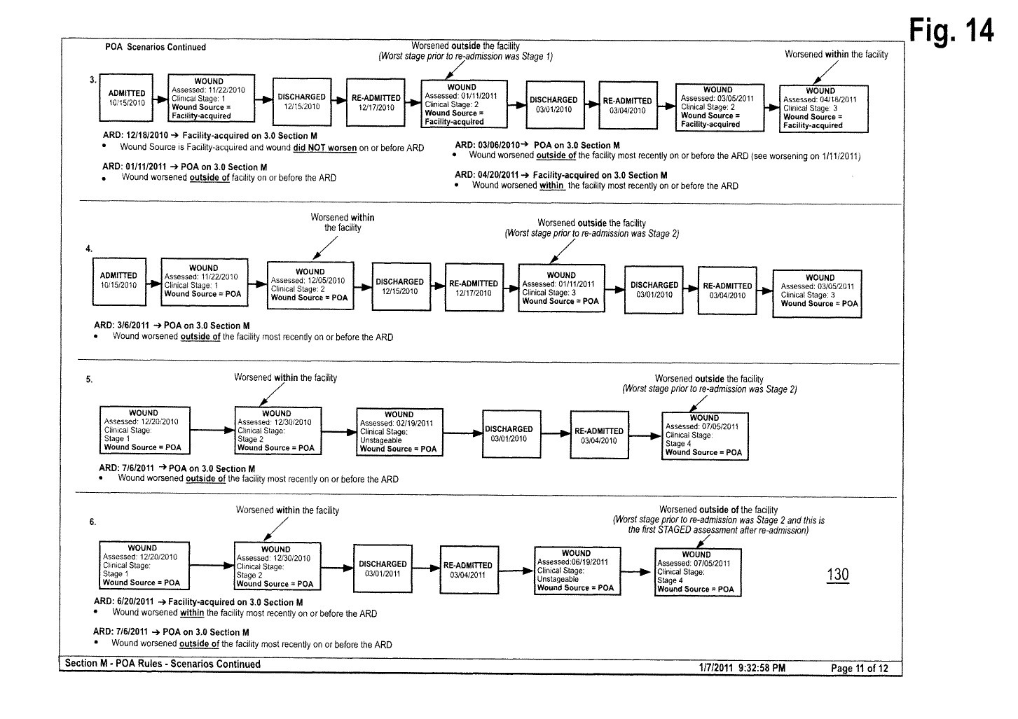

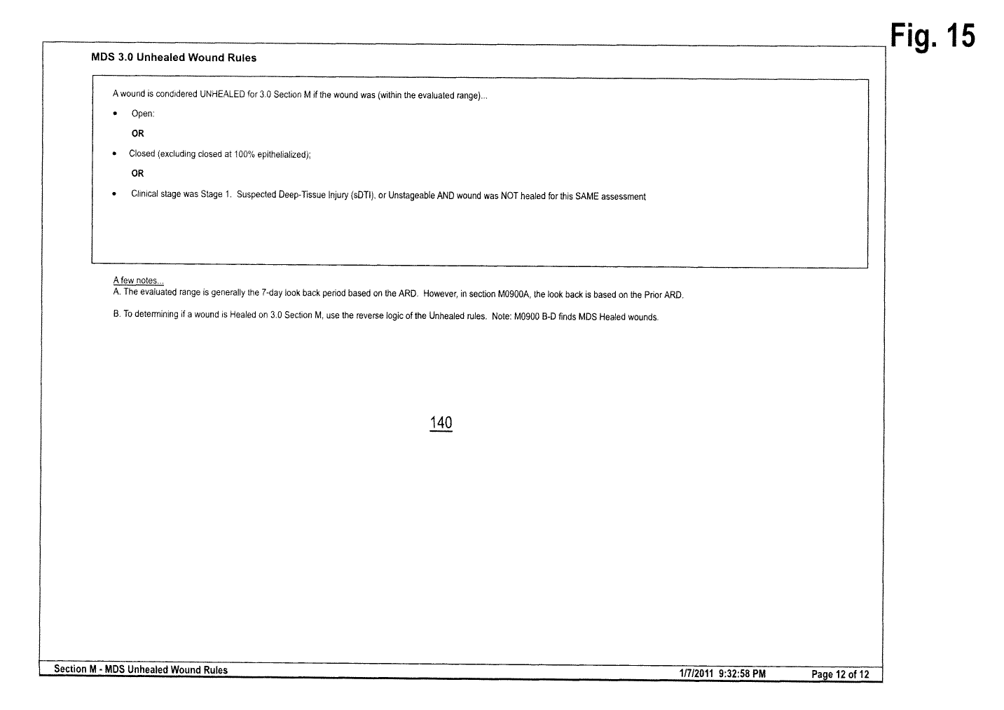

FIGS. 14-15, which depict an exemplary embodiment of a rule section of an embodiment of the present invention, show a second and third rule section page 130 and 140, respectively, of the software application for the prevention, management, and/or treatment of wounds.

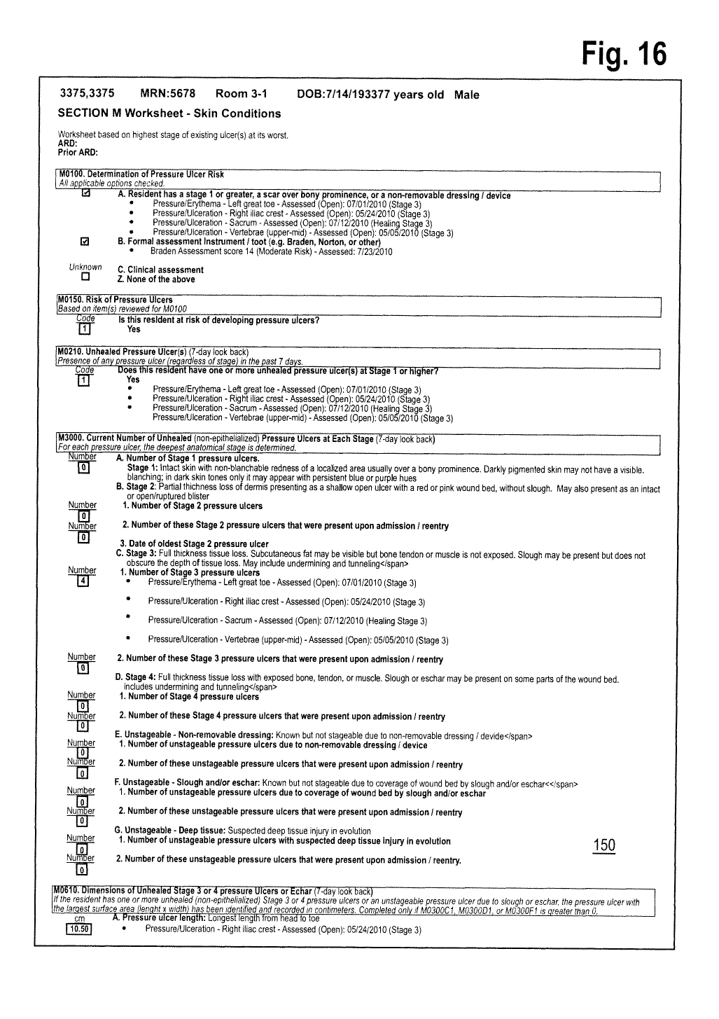

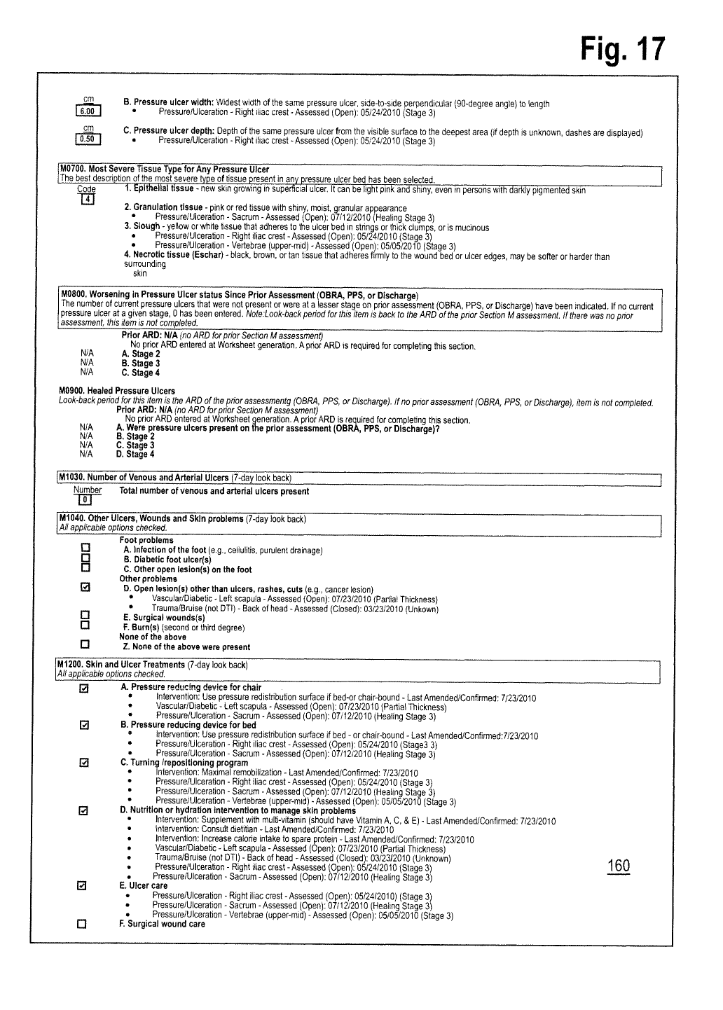

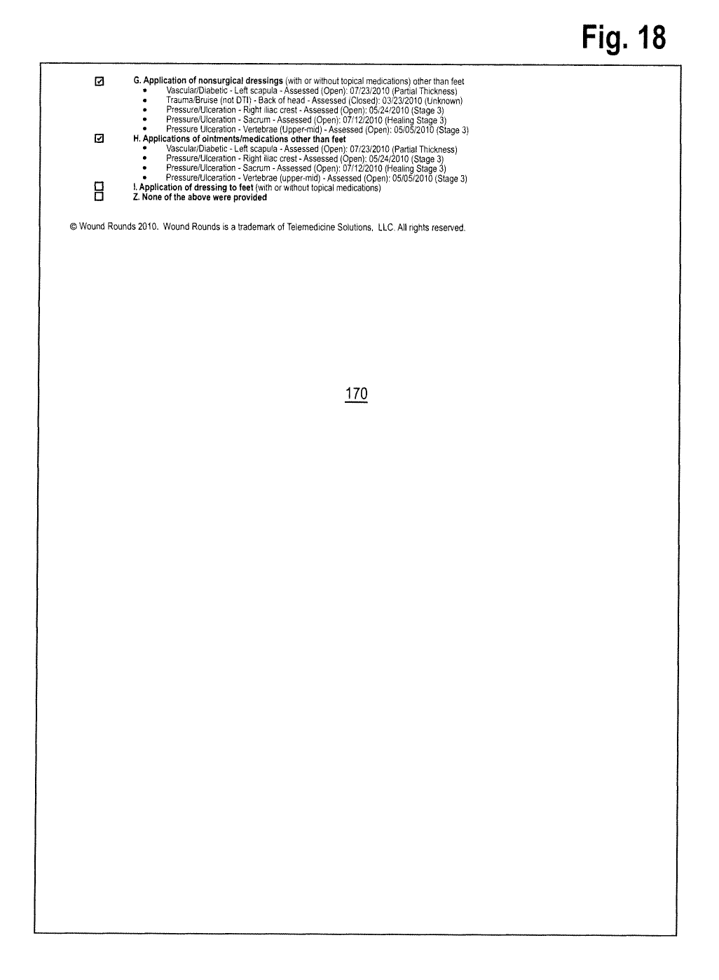

FIGS. 16-18, which depict exemplary worksheet pages from an embodiment of the present invention show a first, second, and third worksheet printout page, 150, 160, and 170, respectively, of the software application for the prevention, management, and/or treatment of wounds.

The method and system for wound care and management can be stored on a computer readable medium as computer executable instructions. The method runs on a system comprising of a mobile device, computing device, storage device and a display. The computing device executes the computer executable instructions contained in the computer readable medium and the display displays the graphic worksheet generated by the method of the present invention.

The foregoing description of an illustrated embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A method for the prevention, management, and/or treatment of wounds, the method comprising the steps of:
a. entering patient information;
b. storing patient information;
c. populating a worksheet with the patient information;
d. dynamically updating the worksheet by extracting and calculating changes in wound status over time; and
e. displaying the worksheet.

2. The method of claim 1, wherein the patient information is wound assessment data.

3. The method of claim 1, wherein the worksheet is an electronic representation of a form.

4. The method of claim 2, wherein the wound assessment data is of a type listed in Section M of the MDS 3.0.

5. The method of claim 3, wherein the form is Section M of the MDS 3.0.

6. The method of claim 1, further comprising the step of displaying the worksheet as an electronic document.

7. The method of claim 1, further comprising the step of printing the worksheet as a physical document.

8. The method of claim 1, further comprising the step of transmitting the patient information to a server database.

9. A computer readable medium having stored thereon computer executable instruction for wound care and management, comprising:
a. entering patient information;
b. storing patient information;
c. populating a worksheet with the patient information;
d. dynamically updating the worksheet by extracting and calculating changes in wound status over time; and
e. displaying the worksheet.

10. The computer readable medium of claim 9, wherein the patient information is wound assessment data.

11. The computer readable medium of claim 9, wherein the worksheet is an electronic representation of a form.

12. The computer readable medium of claim 10, wherein the wound assessment data is of a type listed in Section M of the MDS 3.0.

13. The computer readable medium of claim 11, wherein the form is Section M of the MDS 3.0.

14. The computer readable medium of claim 10, further comprising the step of displaying a set of rules for classifying wounds with regard to a patient's admission to a caretaking facility.

15. The computer readable medium of claim 10, further comprising the step of printing the worksheet as an electronic document.

16. The computer readable medium of claim 10, further comprising the step of printing the worksheet as a physical document.

17. The computer readable medium of claim 10, further comprising the step of transmitting the patient information to a server database.

18. A system for wound care and management, the system comprising:
a. a mobile device for:
i. entering patient information;
b. a computing device for:
i. receiving patient information;
ii. populating a worksheet with the patient information; and
iii. dynamically updating the worksheet; and
c. a storage device for:
i. receiving and storing patient information;
d. a display for:
i. displaying the worksheet; and
e. a software application associated with the mobile device, computing device, storage device, and display for receiving the patient information from the user and populating a worksheet with the patient information and dynamically updating and displaying the worksheet to the user through the display device.

19. The system of claim 18, wherein the patient information is wound assessment data.

20. The system of claim 18, wherein the worksheet is an electronic representation of a form.

21. The system of claim 19, wherein the wound assessment data is of a type listed in Section M of the MDS 3.0.

22. The system of claim 20, wherein the form is Section M of the MDS 3.0.

23. The system of claim 18, wherein the display is capable of displaying a set of rules for classifying wounds with regard to a patient's admission to a caretaking facility.

24. The system of claim 18, wherein the software application has an option allowing the user to see links, alerts, or messages, and when the option is not enabled by the user, the links, alerts, or messages are suppressed.

25. The system of claim 24, wherein the alerts are displayed when a plurality of wounds exist for a same wound site.

26. The system of claim 18, further comprising a printer capable of printing the worksheet as an electronic document.

27. The system of claim 18, further comprising a printer capable of printing the worksheet as a physical document.

28. The system of claim 18, further comprising a transmitting device capable of transmitting the patient information to a server database.
